(19) United States
(12) Patent Application Publication
(10) Pub. No.: US 2025/0183948 A1
(43) Pub. Date: Jun. 5, 2025

(54) SYSTEMS, DEVICES, AND METHODS FOR REALIZING POWER EFFICIENCY IN MASSIVE MULTIPLE-INPUT-MULTIPLE-OUTPUT (MIMO) SYSTEMS

(71) Applicant: Intel Corporation, Santa Clara, CA (US)

(72) Inventors: Kuilin Clark CHEN, Portland, OR (US); Yi LIANG, Beijing (CN); Lu LU, Hillsboro, OR (US); Wenbin WU, Beijing (CN); Wenquan ZHANG, Beijing (CN); Xiaowen ZHANG, Shanghai (CN); Thushara HEWAVITHANA, Tempe, AZ (US)

(21) Appl. No.: 18/393,742

(22) Filed: Dec. 22, 2023

(30) Foreign Application Priority Data
Dec. 1, 2023 (WO) PCT/CN2023/135988

(51) Int. Cl. H04B 7/0426; H04B 7/0456; H04W 28/02

(52) U.S. Cl. CPC H04B 7/0447; H04B 7/0465; H04W 28/0268

(57) ABSTRACT

A base station operates in a massive multiple-input multiple-output (MIMO) and includes an antenna array comprising a plurality of antenna elements, radio frequency circuitry comprising a plurality of radio frequency (RF) chains coupled to a plurality of antennas from an antenna array and are configured to create radio frequency signals from baseband signals. The baseband circuitry includes at least one processor and coupled to the RF circuitry, the base band circuitry configured to cause the apparatus to implement a dynamic power efficiency operation based on current network traffic requirements.

### CROSS-REFERENCE TO RELATED APPLICATION(S)

This application claims priority to International Application No. PCT/CN2023/135988, filed Dec. 1, 2023, the contents of which are incorporated by reference in their entirety.

### FIELD

The present disclosure generally relates to wireless communication devices and methods for performing wideband wireless communication in massive MIMO communication systems.

### BACKGROUND

Multiple-Input-Multiple-Output (MIMO) is widely used for modern wireless communication systems, for example, for Long Term Evolution (LTE) wireless communication systems, and systems beyond LTE, for example, 5^{th} Generation (5G) wireless communication systems. In a MIMO communication system, multiple antennas are used at both transmitters and receivers. Also, a MIMO communication system makes it possible to send and receive more than one data signal on a same radio channel at a same time. For advanced wireless communication, massive MIMO technology is under development. In a massive MIMO communication system, a large number of antennas, transmitters, and receivers are employed for a wide range of frequency carriers. Such a system greatly increases system capacity, extends coverage of cells, and reduces level of interference.

Further, the introduce of higher and higher bands like millimeter waves (mmWave) helps to provide huge spectrum like 2 GHz in 28 GHz, or even more on 60 and 73 GHz. Due to higher penetration loss at these bands, they are mostly suitable for limited hot spot coverage. However, ow band (less than 6 GHz) has become more important. Popular low bands include 3.5 GHZ, 2.6 GHz, 6 GHz newly located or even lower bands like 600 MHz, 700 MHz can be leveraged for 5G coverage. With 100 MHz/200 MHz and 3D-MIMO with 64/128 antenna array unit that can support approximately 8 to 12 co-current streams in downlink, and 5G network can support approximately 1 Gbps DL throughput in real deployment environment, as verified in many nations' commercial deployment.

After large scale deployment, the power consumption of 5G Base Station become a BIG issue for the operators. 5G Base Station power consumption is approximately 2.2 to 2.3 kW in idle status or approximately 3.7 to 3.9 kW in busy status, which three times (3×) over traditional 4G base stations (e.g., 8T8R or 2T2R). The main power consumption if from an active antenna unit (AAU), 320 W peak transmission power, approximately 660 to 1000 W consumed power (with reasonable RF efficiency) per sector.

The power bill of a Base station is approximately $7500 per year, and usually air conditioning will consume at least the same amount of power to cool the base station, adding another $7500 per year, or total $15,000 energy cost, which an operator may not be able to afford. The power bill is a serious threaten to the profitability of 5G.

For massive MIMO AAU, sidelobes are a headache for Massive MIMO systems equipped with beamforming technique. One technique, taper, is frequently used to suppress sidelobes, but the drawback is it back-offs the emission power to some extent, which is problem in terms of power efficiency problem for massive MIMOs.

Currently reported methods include completely turning off the 5G base station when the workload is light at certain time, for e.g. during middle night. These solutions for 5G base station are not flexible at all as turning on/off 5G base stations will impact the system coverage and could lead to various network problems.

Further, known methods to suppress sidelobes while maintaining emission power rely on advanced algorithms in baseband to mitigate the interference caused by the sidelobe abovementioned. However, for the complexity involved in using a baseband algorithm to suppress the sidelobes' is remarkably high, which sometimes a system cannot afford. Such methods are also overly sensitive to channel estimation accuracy, which leads to deterioration of the system throughput if the channel estimation accuracy is not good enough.

### BRIEF DESCRIPTION OF THE DRAWINGS

In the drawings, like reference characters generally refer to the same parts throughout the different view. The drawings are not necessarily to scale, emphasis instead generally being place upon illustrating the principles of the present disclosure. In the following description, various aspects are described with reference to the following drawings.

FIG. 1 shows a wireless communication system, for example, a LTE wireless communication system, a 5G/6G wireless communication system in accordance with some embodiments of the present disclosure.

FIG. 2 shows aspects of a wireless communication device/system in accordance with some embodiments of the present disclosure.

FIG. 3 illustrates an example of infrastructure equipment 300 in accordance with various embodiments.

FIG. 4 illustrates example components of baseband circuitry and radio front end modules in accordance with some embodiments.

FIG. 5 includes graphs of power envelopes are produced in MIMO systems.

FIG. 6 includes a graph of power envelopes for sub-arrays of antennas of an antenna array in accordance with aspects of the present disclosure.

FIG. 7 shows an example of an environment 700 for a MIMO system in accordance with aspects of the present disclosure.

FIG. 8 shows a graph of plots of transmission bandwidth versus power for transmission of a base station implementing a power saving or power efficiency scheme in accordance with aspects of the present disclosure.

FIG. 9 shows a graph of plots of transmission bandwidth versus power for transmission of a base station implementing a power saving or power efficiency scheme in accordance with aspects of the present disclosure.

FIG. 10 includes a table 1000 showing characteristics for implementing power efficiency techniques in accordance with aspects of the present disclosure.

FIG. 11 shows a method according to at least one aspect of the present disclosure

### DETAILED DESCRIPTION

The following detailed description refers to the accompanying drawings that show, by way of illustration, specific details and aspects of the present disclosure. Other aspects may be utilized and structural, logical, and electrical changes may be made without departing from the scope of the present disclosure. The various aspects of the present disclosure are not necessarily mutually exclusive, as some aspects of the present disclosure can be combined with one or more other aspects of the present disclosure to form new aspects.

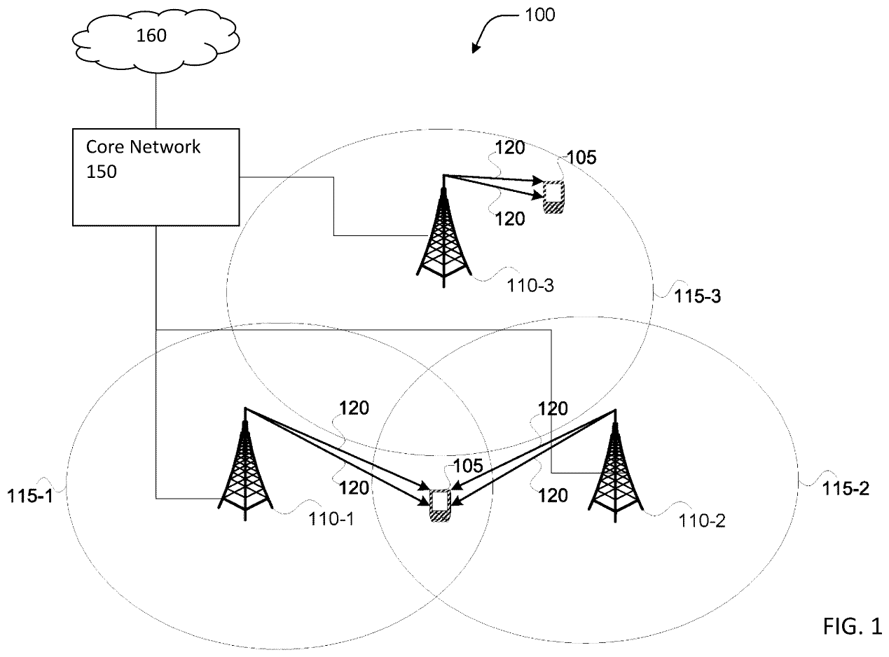

FIG. 1 shows a wireless communication system 100, for example, a LTE wireless communication system, and systems beyond LTE, for example, a 5G/6G wireless communication system in accordance with some embodiments.

The wireless communication system 100, for example, a LTE or a 5G wireless communication system, includes a radio access network. The radio access network may include base stations 120-122 (e.g. eNodeBs, eNBs, according to LTE). Each base station, for example, the base station 120 may provide radio coverage for one or more mobile radio cells, for example, mobile radio cell 110, of the radio access network 101.

A plurality of wireless communication devices 105 (also referred to as mobile terminals, User Equipment (UEs), Mobile Stations (MS), mobile devices, receivers, transmitters, or transceivers) may be located in the mobile radio cell 115 (115-1-115-3) of the wireless communication system 100. A wireless communication device, for example, wireless communication device 105 may communicate with other wireless communication devices, for example, wireless communication device 131 or 132, via a base station, for example, base station 120, providing coverage for (in other words, operating) the mobile radio cell, for example, mobile radio cell 115.

For radio communication via an air interface channel, for example, channel 120, a wireless communication device, for example, base station 110 or wireless communication device 130, may include a chain of Radio Frequency (RF), and a plurality of antennas, and a baseband processor. A chain of RF which may also be referred to as an RF chain may include an RF receiver, an RF transmitter, or an RF transceiver. A plurality of antennas may form multiple antenna arrays. A baseband processor may include, for example, an analog baseband to provide analog signal processing, an Analog-to-Digital Converter (ADC) and Digital-to-Analog Converter (DAC) to provide conversions between the analog and digital domains, and a digital baseband to provide digital signal processing. A chain of RF may be also a physical RF block that may process multiple parallel signals.

The wireless communication devices 105 may be within coverage of one or more mobile communication networks that may operate according to a same RAT (Radio Access Technology) or according to different RATs.

The radio access network may support communication according to various communication technologies, e.g. mobile communication standards. Each base station, for example, 120, may provide a radio communication connection via an air interface channel, for example, channel 140, between the base station 120 and a wireless communication device, for example, wireless communication device 130, according to 5G, LTE, Universal Mobile Telecommunications System (UMTS), Global System for Mobile Communications (GSM), Enhanced Data Rates for GSM Evolution (EDGE) radio access.

As shown by FIG. 1, links 120 between base station 110 and a UE 105 may include one or more downlink (or forward) channels for transmitting information from base station 110 to UE 105. Although not shown by FIG. 1, links 120 may also include one or more uplink (or reverse) channels for transmitting information from UE 105 to the base station 110. The channels may include the physical downlink shared channel (PDSCH), physical downlink control channel (PDCCH), physical hybrid automatic repeat request (HARQ) indicator channel (PHICH), physical control format indicator channel (PCFICH), physical broadcast channel (PBCH), physical uplink shared channel (PUSCH), physical uplink control channel (PUCCH), physical random access channel (PRACH), and/or any other like communications channels or links used to transmit/receive data.

The wireless network or wireless communication 100 may further include a core network 150, with which the one or more base stations/access nodes 120 may interface, e.g. via backhaul interfaces. The core network 150 may be or may include an Evolved Packet Core (EPC, for LTE), Core Network (CN, for UMTS), 5G core network (5GC), as examples, or other cellular core networks. The core network 150 may interface with one or more external data networks 160, e.g. via a suitable interface. The core network 150 may provide switching, routing, and transmission, for traffic data related to wireless communication devices 105, and may further provide access to various internal data networks (e.g., control nodes, routing nodes that transfer information between other wireless communication devices on wireless network 100, etc.) and external data networks 160 (e.g., data networks providing voice, text, multimedia (audio, video, image), and other Internet and application data). As an example, the one or more external data networks 160 may include one or more packet data networks, PDNs. A wireless communication device or UE 105 may thus establish a data connection with external data networks 130 via a network access node/base station 120 and core network 150 for data transfer and routing.

The access network, e.g., the plurality of base stations 120 and the core network 150 may be governed by communication protocols that can vary depending on the specifics of wireless network 100. Such communication protocols may define the scheduling, formatting, and routing of both user and control data traffic through wireless network 100, which includes the transmission and reception of such data through both the radio access and core network domains of wireless network 100. Accordingly, wireless communication devices 105 and network access nodes/base stations 120 may follow the defined communication protocols to transmit and receive data over the radio access network domain of wireless network 100, while the core network 150 may follow the defined communication protocols to route data within and outside of the core network 150. Exemplary communication protocols include LTE, UMTS, GSM, WiMAX, Bluetooth, WiFi, mmWave, etc., any of which may be applicable to wireless network 100.

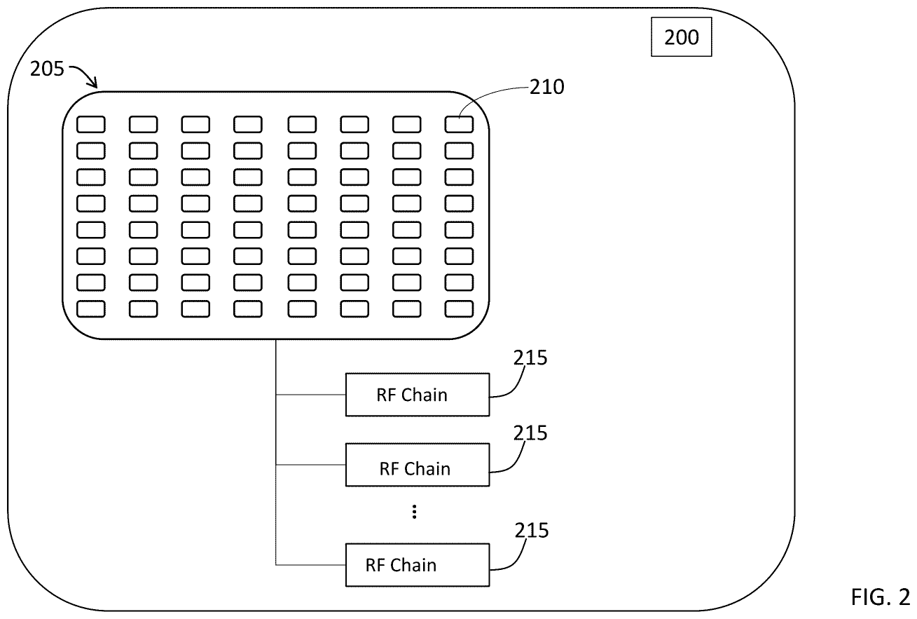

FIG. 2 shows aspects of a wireless communication device/system 200, e.g., a base station. The device 200 includes an antenna array 205 of antenna elements or antennas 210. The antenna array 205 can produce beams to transmit data, e.g., to UEs. The system 200 can be a base station operating in a MIMO system. The antenna array 205 can produce beams according any suitable MIMO system, including massive MIMO, MU-MIMO, single/multi-Cell massive MIMO systems, etc. The example of FIG. 2, the antenna array can be coupled to a plurality of RF chains 215. The RF chains 215 may be further coupled to circuitry, e.g., baseband circuitry as described in examples herein.

For example, an RF chain 215, which may include an associated antenna element 210, can comprise the following components: Amplifiers (e.g., a Low Noise Amplifier (LNA), Power Amplifier, etc.), Filters (e.g., Bandpass filter), a Mixer, a Frequency Synthesizer, a Power Amplifier (PA), Digital Signal Processing (DSP), Automatic Gain Control (AGC), RF Switches, Digital-to-Analog Converters (DACs), and Analog-to-Digital Converters (ADCs). Each RF chain 215 can generate a carrier signal and may include an oscillator for this purpose. These RF chains 215 can generate signals, such as carrier signals at one or more frequencies, to provide different bandwidths for the system.

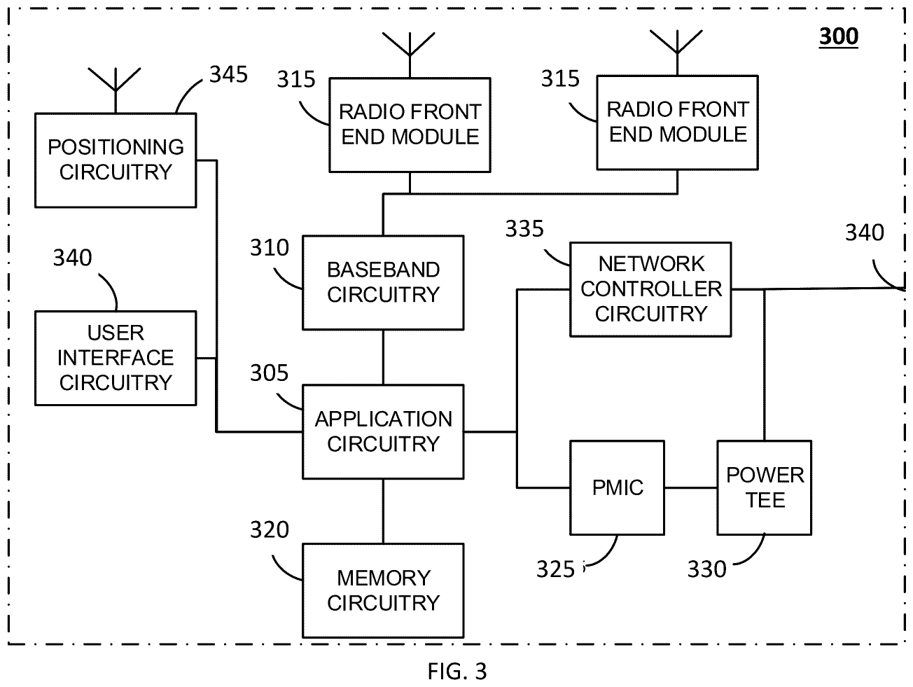

FIG. 3 illustrates an example of infrastructure equipment 300 in accordance with various embodiments. The infrastructure equipment 300 (or “system 300”) may be implemented as a base station, radio head, RAN node, etc. In other examples, the system 300 could be implemented in or by a UE, application server(s), and/or any other element/device discussed herein. The system 300 may include one or more of application circuitry 305, baseband circuitry 310, one or more radio front end modules 315, memory 320, power management integrated circuitry (PMIC) 325, power tee circuitry 330, network controller 335, network interface connector 340, satellite positioning circuitry 345, and user interface 350. In some embodiments, the device 300 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

As used herein, the term “circuitry” may refer to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality. In addition, the term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

As utilized herein, terms “module”, “component,” “system,” “circuit,” “element,” “slice,” “circuitry,” may refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term “set” can be interpreted as “one or more.”

The terms “application circuitry” and/or “baseband circuitry” may be considered synonymous to, and may be referred to as “processor circuitry”. As used herein, the term “processor circuitry” may refer to, is part of, or includes circuitry capable of sequentially and automatically carrying out a sequence of arithmetic or logical operations; and recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

Furthermore, the various components of a core network (C=) may be referred to as “network elements”. The term “network element” may describe a physical or virtualized equipment used to provide wired or wireless communication network services. The term “network element” may be considered synonymous to and/or referred to as a networked computer, networking hardware, network equipment, network node, router, switch, hub, bridge, radio network controller, radio access network device, gateway, server, virtualized network function (VNF), network functions virtualization infrastructure (NFVI), and/or the like.

Application circuitry 305 may include one or more central processing unit (CPU) cores and one or more of cache memory, low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD/) MultiMediaCard (MMC) or similar, Universal Serial Bus (USB) interfaces, Mobile Industry Processor Interface (MIPI) interfaces and Joint Test Access Group (JTAG) test access ports. As examples, the application circuitry 305 may include one or more Intel Pentium®, Core®, or Xeon® processor(s); Advanced Micro Devices (AMD) Ryzen® processor(s), Accelerated Processing Units (APUs), or Epyc® processors; and/or the like. In some embodiments, the system 300 may not utilize application circuitry 305, and instead may include a special-purpose processor/controller to process IP data received from an EPC or 5GC, for example.

Additionally or alternatively, application circuitry 305 may include circuitry such as, but not limited to, one or more field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry 305 may include logic blocks or logic fabric including other interconnected resources that may be programmed to perform various functions, such as the procedures, methods, functions, etc. of the various embodiments discussed herein. In such embodiments, the circuitry of application circuitry 305 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in lookup-tables (LUTs) and the like.

The baseband circuitry 310 may be implemented, for example, as a solder-down substrate including one or more integrated circuits, a single packaged integrated circuit soldered to a main circuit board or a multi-chip module containing two or more integrated circuits. Although not shown, baseband circuitry 310 may include one or more digital baseband systems, which may be coupled via an interconnect subsystem to a CPU subsystem, an audio subsystem, and an interface subsystem. The digital baseband subsystems may also be coupled to a digital baseband interface and a mixed-signal baseband sub-system via another interconnect subsystem. Each of the interconnect subsystems may include a bus system, point-to-point connections, network-on-chip (NOC) structures, and/or some other suitable bus or interconnect technology, such as those discussed herein. The audio sub-system may include digital signal processing circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry 310 may include protocol processing circuitry with one or more instances of control circuitry (not shown) to provide control functions for the digital baseband circuitry and/or radio frequency circuitry (for example, the radio front end modules 315).

User interface circuitry 350 may include one or more user interfaces designed to enable user interaction with the system 300 or peripheral component interfaces designed to enable peripheral component interaction with the system 300. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a non-volatile memory port, a universal serial bus (USB) port, an audio jack, a power supply interface, etc.

The radio front end modules (RFEMs) 315 may include a millimeter wave RFEM and one or more sub-millimeter wave radio frequency integrated circuits (RFICs). In some implementations, the one or more sub-millimeter wave RFICs may be physically separated from the millimeter wave RFEM. The RFICs may include connections to one or more antennas or antenna arrays, and the RFEM may be connected to multiple antennas. In alternative implementations, both millimeter wave and sub-millimeter wave radio functions may be implemented in the same physical radio front end module 315. The RFEMs 315 may incorporate both millimeter wave antennas and sub-millimeter wave antennas.

The memory circuitry 320 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 320 may be implemented as one or more of solder down packaged integrated circuits, socketed memory modules and plug-in memory cards.

The PMIC 325 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 330 may provide for electrical power drawn from a network cable to provide both power supply and data connectivity to the infrastructure equipment 300 using a single cable.

The network controller circuitry 335 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 300 via network interface connector 340 using a physical connection, which may be electrical (commonly referred to as a “copper interconnect”), optical, or wireless. The network controller circuitry 335 may include one or more dedicated processors and/or FPGAs to communicate using one or more of the aforementioned protocol. In some implementations, the network controller circuitry 335 may include multiple controllers to provide connectivity to other networks using the same or different protocols.

The positioning circuitry 345 may include circuitry to receive and decode signals transmitted by one or more navigation satellite constellations of a global navigation satellite system (GNSS). Examples of navigation satellite constellations (or GNSS) may include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 345 may include various hardware elements (e.g., including hardware devices such as switches, filters, amplifiers, antenna elements, and the like to facilitate the communications over-the-air (OTA) communications) to communicate with components of a positioning network, such as navigation satellite constellation nodes.

Nodes or satellites of the navigation satellite constellation(s) (“GNSS nodes”) may provide positioning services by continuously transmitting or broadcasting GNSS signals along a line of sight, which may be used by GNSS receivers (e.g., positioning circuitry 345 and/or positioning circuitry implemented by UEs 101, 102, or the like) to determine their GNSS position. The GNSS signals may include a pseudorandom code (e.g., a sequence of ones and zeros) that is known to the GNSS receiver and a message that includes a time of transmission (ToT) of a code epoch (e.g., a defined point in the pseudorandom code sequence) and the GNSS node position at the TOT. The GNSS receivers may monitor/measure the GNSS signals transmitted/broadcasted by a plurality of GNSS nodes (e.g., four or more satellites) and solve various equations to determine a corresponding GNSS position (e.g., a spatial coordinate). The GNSS receivers also implement clocks that are typically less stable and less precise than the atomic clocks of the GNSS nodes, and the GNSS receivers may use the measured GNSS signals to determine the GNSS receivers' deviation from true time (e.g., an offset of the GNSS receiver clock relative to the GNSS node time). In some embodiments, the positioning circuitry 345 may include a Micro-Technology for Positioning, Navigation, and Timing (Micro-PNT) IC that uses a master timing clock to perform position tracking/estimation without GNSS assistance.

The GNSS receivers may measure the time of arrivals (ToAs) of the GNSS signals from the plurality of GNSS nodes according to its own clock. The GNSS receivers may determine time of flight (ToF) values for each received GNSS signal from the ToAs and the ToTs, and then may determine, from the ToFs, a three-dimensional (3D) position and clock deviation. The 3D position may then be converted into a latitude, longitude and altitude. The positioning circuitry 345 may provide data to application circuitry 305, which may include one or more of position data or time data. Application circuitry 305 may use the time data to synchronize operations with other radio base stations (e.g., RAN nodes or the like).

The components shown by FIG. 3 may communicate with one another using interface circuitry. As used herein, the term “interface circuitry” may refer to, is part of, or includes circuitry providing for the exchange of information between two or more components or devices. The term “interface circuitry” may refer to one or more hardware interfaces, for example, buses, input/output (I/O) interfaces, peripheral component interfaces, network interface cards, and/or the like. Any suitable bus technology may be used in various implementations, which may include any number of technologies, including industry standard architecture (ISA), extended ISA (EISA), peripheral component interconnect (PCI), peripheral component interconnect extended (PCIx), PCI express (PCIe), or any number of other technologies. The bus may be a proprietary bus, for example, used in a SoC based system. Other bus systems may be included, such as an I2C interface, an SPI interface, point to point interfaces, and a power bus, among others.

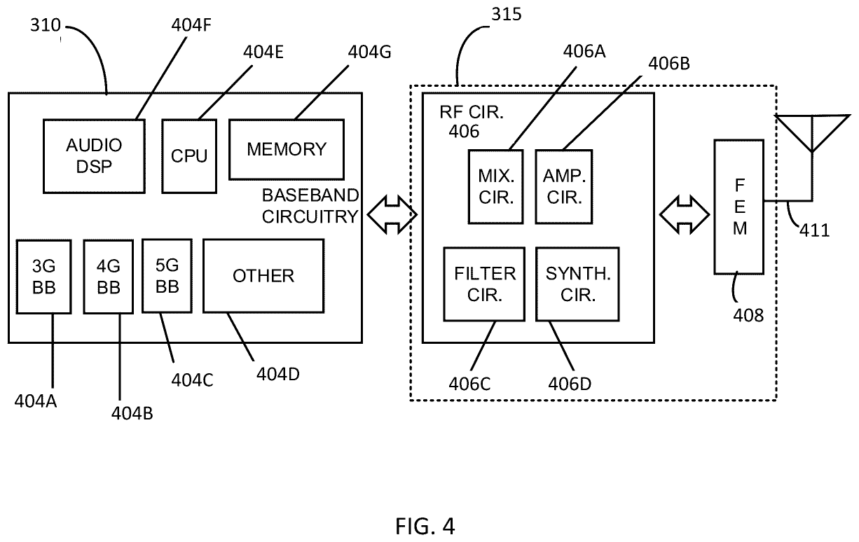

FIG. 4 illustrates example components of baseband circuitry 310 and radio front end modules (RFEM) 315 (e.g., RF chain) or in accordance with some embodiments. As shown, the RFEM 315 may include Radio Frequency (RF) circuitry 406, front-end module (FEM) circuitry 408, one or more antennas 411 coupled together at least as shown.

The baseband circuitry 310 may include circuitry such as, but not limited to, one or more single-core or multi-core processors. The baseband circuitry 310 may include one or more baseband processors or control logic to process baseband signals received from a receive signal path of the RF circuitry 406 and to generate baseband signals for a transmit signal path of the RF circuitry 406. Baseband processing circuitry 310 may interface with the application circuitry 305 for generation and processing of the baseband signals and for controlling operations of the RF circuitry 406. For example, in some embodiments, the baseband circuitry 310 may include a third generation (3G) baseband processor 404A, a fourth generation (4G) baseband processor 404B, a fifth generation (5G) baseband processor 404C, or other baseband processor(s) 404D (e.g., 6G) for other existing generations, generations in development or to be developed in the future (e.g., second generation (2G), sixth generation (6G), etc.). The baseband circuitry 310 (e.g., one or more of baseband processors 404A-D) may handle various radio control functions that enable communication with one or more radio networks via the RF circuitry 406. In other embodiments, some or all of the functionality of baseband processors 404A-D may be included in modules stored in the memory 404G and executed via at least one Central Processing Unit (CPU) 404E. The radio control functions may include, but are not limited to, signal modulation/demodulation, encoding/decoding, radio frequency shifting, etc. In some embodiments, modulation/demodulation circuitry of the baseband circuitry 310 may include Fast-Fourier Transform (FFT), precoding, or constellation mapping/demapping functionality. In some embodiments, encoding/decoding circuitry of the baseband circuitry 310 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 310 may include one or more audio digital signal processor(s) (DSP) 404F. The audio DSP(s) 404F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 310 and the application circuitry 305 may be implemented together such as, for example, on a system on a chip (SoC).

In some embodiments, the baseband circuitry 310/410 may provide for communication compatible with one or more radio technologies. For example, in some embodiments, the baseband circuitry 310/410 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 310/410 is configured to support radio communications of more than one wireless protocol may be referred to as multi-mode baseband circuitry.

RF circuitry 406 may enable communication with wireless networks using modulated electromagnetic radiation through a non-solid medium. In various embodiments, the RF circuitry 406 may include switches, filters, amplifiers, etc. to facilitate the communication with the wireless network. RF circuitry 406, e.g., RF chain, may include a receive signal path which may include circuitry to down-convert RF signals received from the FEM circuitry 408 and provide baseband signals to the baseband circuitry 310. RF circuitry 406 may also include a transmit signal path which may include circuitry to up-convert baseband signals provided by the baseband circuitry 310/410 and provide RF output signals to the FEM circuitry 408 for transmission.

In some embodiments, the receive signal path of the RF circuitry 406 may include mixer circuitry 406A, amplifier circuitry 406B and filter circuitry 406C. In some embodiments, the transmit signal path of the RF circuitry 406 may include filter circuitry 406C and mixer circuitry 406A. RF circuitry 406 may also include synthesizer circuitry 406D for synthesizing a frequency for use by the mixer circuitry 406A of the receive signal path and the transmit signal path. In some embodiments, the mixer circuitry 406A of the receive signal path may be configured to down-convert RF signals received from the FEM circuitry 408 based on the synthesized frequency provided by synthesizer circuitry 406D. The amplifier circuitry 406B may be configured to amplify the down-converted signals and the filter circuitry 406C may be a low-pass filter (LPF) or band-pass filter (BPF) configured to remove unwanted signals from the down-converted signals to generate output baseband signals. Output baseband signals may be provided to the baseband circuitry 310 for further processing. In some embodiments, the output baseband signals may be zero-frequency baseband signals, although this is not a requirement. In some embodiments, mixer circuitry 406A of the receive signal path may include passive mixers, although the scope of the embodiments is not limited in this respect.

In some embodiments, the mixer circuitry 406A of the transmit signal path may be configured to up-convert input baseband signals based on the synthesized frequency provided by the synthesizer circuitry 406D to generate RF output signals for the FEM circuitry 408. The baseband signals may be provided by the baseband circuitry 310 and may be filtered by filter circuitry 406C.

In some embodiments, the mixer circuitry 406A of the receive signal path and the mixer circuitry 406A of the transmit signal path may include two or more mixers and may be arranged for quadrature downconversion and upconversion, respectively. In some embodiments, the mixer circuitry 406A of the receive signal path and the mixer circuitry 406A of the transmit signal path may include two or more mixers and may be arranged for image rejection (e.g., Hartley image rejection). In some embodiments, the mixer circuitry 406A of the receive signal path and the mixer circuitry 406A may be arranged for direct downconversion and direct upconversion, respectively. In some embodiments, the mixer circuitry 406A of the receive signal path and the mixer circuitry 406A of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 406 may include analog-to-digital converter (ADC) and digital-to-analog converter (DAC) circuitry and the baseband circuitry 310 may include a digital baseband interface to communicate with the RF circuitry 406.

In some dual-mode embodiments, a separate radio IC circuitry may be provided for processing signals for each spectrum, although the scope of the embodiments is not limited in this respect.

In some embodiments, the synthesizer circuitry 406D may be a fractional-N synthesizer or a fractional N/N+1 synthesizer, although the scope of the embodiments is not limited in this respect as other types of frequency synthesizers may be suitable. For example, synthesizer circuitry 406D may be a delta-sigma synthesizer, a frequency multiplier, or a synthesizer including a phase-locked loop with a frequency divider.

The synthesizer circuitry 406D may be configured to synthesize an output frequency for use by the mixer circuitry 406A of the RF circuitry 406 based on a frequency input and a divider control input. In some embodiments, the synthesizer circuitry 406D may be a fractional N/N+1 synthesizer.

In some embodiments, frequency input may be provided by a voltage controlled oscillator (VCO), although that is not a requirement. Divider control input may be provided by either the baseband circuitry 310 or the applications processor 305 depending on the desired output frequency. In some embodiments, a divider control input (e.g., N) may be determined from a lookup table based on a channel indicated by the applications processor 305.

Synthesizer circuitry 406D of the RF circuitry 406 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 406D may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 406 may include an IQ/polar converter.

FEM circuitry 408 may include a receive signal path which may include circuitry configured to operate on RF signals received from one or more antennas 411, amplify the received signals and provide the amplified versions of the received signals to the RF circuitry 406 for further processing. FEM circuitry 408 may also include a transmit signal path which may include circuitry configured to amplify signals for transmission provided by the RF circuitry 406 for transmission by one or more of the one or more antennas 411. In various embodiments, the amplification through the transmit or receive signal paths may be done solely in the RF circuitry 406, solely in the FEM 408, or in both the RF circuitry 406 and the FEM 408.

In some embodiments, the FEM circuitry 408 may include a TX/RX switch to switch between transmit mode and receive mode operation. The FEM circuitry may include a receive signal path and a transmit signal path. The receive signal path of the FEM circuitry may include a low noise amplifier (LNA) to amplify received RF signals and provide the amplified received RF signals as an output (e.g., to the RF circuitry 406). The transmit signal path of the FEM circuitry 408 may include a power amplifier (PA) to amplify input RF signals (e.g., provided by RF circuitry 406), and one or more filters to generate RF signals for subsequent transmission (e.g., by one or more of the one or more antennas 411).

Processors of the application circuitry 305 and processors of the baseband circuitry 310 may be used to execute elements of one or more instances of a protocol stack. For example, processors of the baseband circuitry 310, alone or in combination, may be used execute Layer 3, Layer 2, or Layer 1 functionality, while processors of the baseband circuitry 310 may utilize data (e.g., packet data) received from these layers and further execute Layer 4 functionality (e.g., transmission communication protocol (TCP) and user datagram protocol (UDP) layers). As referred to herein, Layer 3 may include a radio resource control (RRC) layer, described in further detail below. As referred to herein, Layer 2 may include a medium access control (MAC) layer, a radio link control (RLC) layer, and a packet data convergence protocol (PDCP) layer, described in further detail below. As referred to herein, Layer 1 may include a physical (PHY) layer of a UE/RAN node, described in further detail below.

Various examples or embodiments of the present disclosure are regarding adaptation methods to improve power efficiency of 5G/6G base stations by scale the system capacity according to the network traffic need while keep the same level of coverage and service quality agreement. In particular, various methods or embodiments relate to:
Dynamically changing the operation bandwidth according to network load, e.g., change from 100 MHz to 20 MHz in idle mode, and change back to 40/60/80/100 MHz in busy model.
Dynamically turn on/off part of the RF chains in AAU depends on network load; Adjust the single-cell MIMO operation mode and/or switch from single-cell massive MIMO to multi-cell joint massive MIMO processing.
Dynamically change baseband processing chip's frequency, turn on/off memory etc/turn off one or more cores. based on processing workload.

A goal in such methods is to make sure the power density level in the coverage area for downlink and the received signal sensitively level in the uplink maintain the service level at different network traffic levels.

For the sidelobe suppression, various embodiments are directed to maintaining the overall power emission, to big extent, while suppressing the sidelobes. One method involves when subarrays are defined for massive MIMO, e.g., in a base station (e.g., 5G or 6G). In one or more examples, an overlap is introduced to the subarray's definition taking the taper into account to make the power along different antenna ports as same as possible. Such an approach can be used for a linear (1-D) antenna system, but also in a multiple dimensional antenna system, e.g., 2D or more/

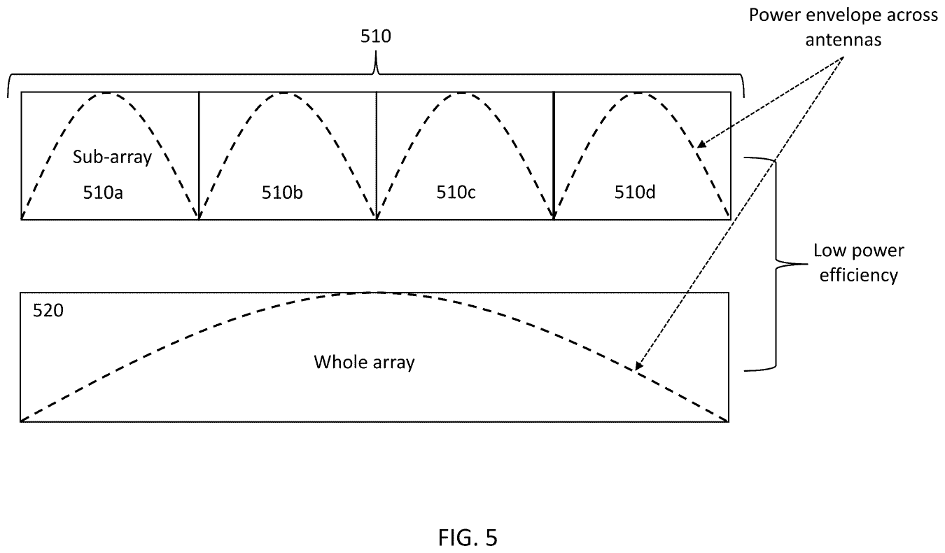

FIG. 5 shows examples of how power envelopes are produced in conventional antenna arrays for MIMO systems. For example, graph 510 shows how a transmitted power from a subarray of antennas 510a-510d is produced. As shown, each sub-array produces a power envelop that tapered. Moreover, each power envelop from a sub-array is tapered so as to not (significantly) overlap with a neighboring sub-array. The graph 520 shows the overall power envelop from the entire array along a single direction.

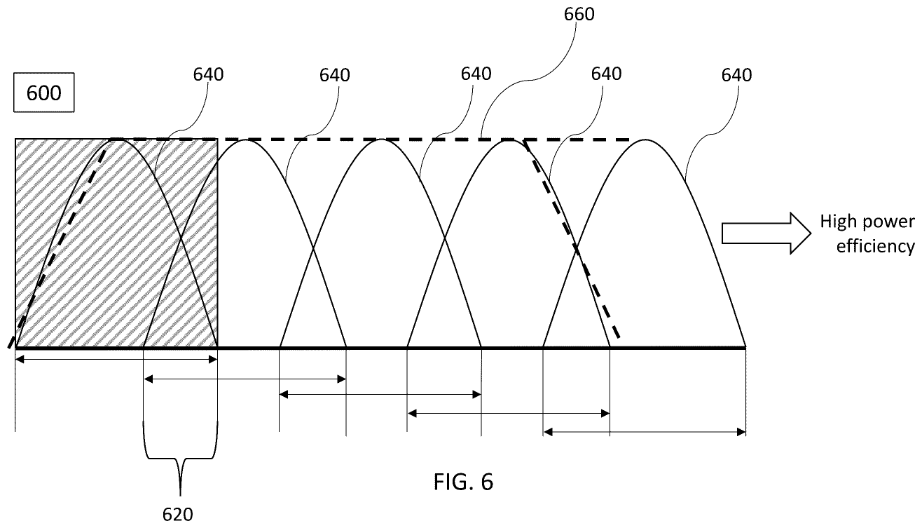

FIG. 6 shows a graph 600 of power envelopes 640 (640a-640e) for sub-arrays of antennas of an antenna array in accordance with aspects of the present disclosure. For example, the sub-arrays can be sub-array of an antenna array, e.g., for a base station implementing (massive) MIMO, for example, sub-arrays of the antenna array 205 of the base station 200. Each sub-array can include a subset of antenna elements of the antenna array.

As shown, in FIG. 6, the sub-arrays have been defined so as to overlap in their transmission. For example, overlapping sub-arrays may mean that all or at least some of the defined sub-arrays can share some common or same antenna elements. For example, spatially adjacent sub-array may be defined to operate with sharing one or more common antenna elements. Said differently, some antenna elements may belong to two or more sub-arrays.

Each sub-array produces a transmit power profile or power envelope 640 across the sub-array. The transmit power profile across each sub-array has a tapering, meaning although the antennas at the middle of the sub-array transmit full power, antennas towards the edge of the sub-array transmit lower power.

However, due to the overlap 620, the overlap between adjacent sub-arrays the overall power profile or power envelope 660 across the entire antenna array is substantially or approximately flat. “Flat” can be interpreted as one skilled in the art would understand. For example, flat here can mean all the antennas transmit close to full power (e.g., less than 1%, between 1% to 5%, 1% to 3%, or 3% to 5%, 1% to 5%, 3% to 10%, or 5% to 10% of full power) thus providing a flat power profile across all the antennas of the antenna array. While FIG. 6 shows the power envelopes for linear antenna arrays, the overlap concept to produce flat power envelope overall with tapering for sub-arrays can be extended to multiple dimensions, e.g., 2D or 3D antenna arrays. In one or more embodiments, a processor, e.g., may be configured to cause a base station to realize such a power envelope using the above-described approach, e.g., defining sub-arrays so that adjacent or immediate neighboring sub-arrays have a degree of overlap and each sub-array producing a tapering power envelope.

For each sub-array to realize power envelopes shown in FIG. 6, a windowing function, e.g., a spatial windowing function, can be each signal to the sub-array after defining the sub-arrays in the overlapping manner. The windowing function can be applied to the signals so that transmission by each sub-array has a tapered power envelope. In one example, circuitry of the system or base station, e.g., baseband circuitry and one or more processors thereof, may be configured to define the sub-arrays for a MIMO in an overlapping fashion and to apply spatial windowing functions to signals for each of the defined overlapping sub-arrays. The spatial windowing function may be applied so that each of the sub-arrays transmits with substantially the same power level and so that a power envelop of the antenna includes a substantially flat part across all the antennas of the antenna array.

Further aspects of the present disclosure relate to adaptive power efficiency schemes. For example, aspects relate to adaptive power efficiency schemes for single and/or multi-cell massive MIMO. Such schemes may be implemented by considering a downlink link budget analysis.

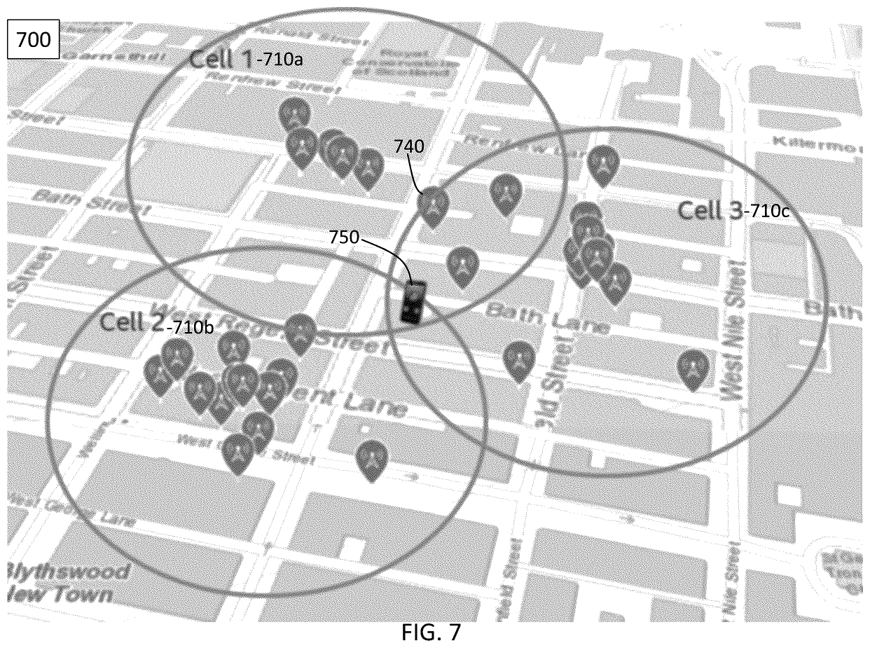

FIG. 7 shows an example of an environment 700 for a MIMO system for a simple case with 3 sectors (cells 710a-c) in a multi-cell system to describe adaptive power efficiency schemes of the present disclosure. The power efficiency scheme described herein are designed to provide the same or better coverage at low network traffic case with less bandwidth and less antenna elements activated.

The representation 700 of a wireless environment, shown in FIG. 7, includes a plurality of base stations 740 which. For instance, the base stations may 5G or 6G base stations. In this case, this may be considered low trafficked network or a low traffic time with only one active wireless device UE 750.

For purposes of describing the power efficiency schemes of the present disclosure, the following system assumptions can be: 3 cells facing each other at 120 degrees separation with 500 m radius; each cell has 64-antenna array for both transmission and receiving. The focus is on downlink transmission because this is important for power saving. The operation frequency can be 3.4 GHz, Time Division Duplex (TDD) mode, with 100 MHz bandwidth. The downlink transmission power can be 26 dBm/PRB (physical resource block) with a 30 kHz subcarrier.

Translating to 100 MHz leads (100 MHz/30 k/12)=250 PRBs, which is 10*log 10 (250)=24 dB. Therefore, the total transmission power would be: 26 dBm+24 dB=50 dBm, which is 100 W or 100,000 mW. With 64 transmission (TX) antenna elements, per TX output power is 1.56 Watt.

In a normal day-time operation model, it can be assumed the UE 750 is attached to cell 1 above and is interference free from other neighbor cells due to scheduling/frequency reuse (an ideal and most favorable situation). Hence the link budget of downlink can be calculated using the following assumptions:
Type of coverage: outdoor
Propagation model: Urban Maco with 3D model
Center frequency for TX, Mhz: 3410
Number of PRB: 1
Subcarrier spacing: 30 kHz

The calculation for downlink link budget includes

$$Path loss = 28 + 22 log 10 ( d ) + 20 log 10 ( fc )$$

$$Received Signal Level at receiver ( dBm ) = gNodeB ( base station ) transmit power ( dBm ) - 10 log 10 ( subcarrier quantity ) + gNodeB antenna gain ( dBi ) - gNodeB cable loss ( dB ) - Path loss ( dB ) - penetration loss ( dB ) - foliage loss ( dB ) - body block loss ( dB ) - interference margin ( dB ) - rain / ice margin ( dB ) - slow fading margin ( dB ) + UE antenna gain ( dB ) - Thermal noise power ( dBm ) - UE noise figure ( dB ) - demodulation threshold SINR ( dB ) * thermal noise = - 174 + 10 log ( bandwidth ( Hz ) )$$

| | |
|---|---|
| Noise figure, dB | 4 |
| Cable loss, dB | 2 |
| Antenna gain, dB | 17.5 (with 64 |
| | antenna array) |
| Antenna height, m | 25 |
| Transmit power, dBm | 23 |
| Slow fading margin, dB | 7 |
| Foliage loss, dB | 8.5 |
| Rain/ice margin, dB | 1 |
| Body loss, dB | 3 |
| Interference margin, dB | 2 |
| Targeted SINR | −2 dB |

| | |
|---|---|
| Cell radius | 500 m |
| Link budget, dBm | −85.21 |
| Reception sensitivity, dBm = | −91.46 |
| noise figure (dB) + thermal | |
| noise(dBm) + SINR(dB) | |

The above calculations are for normal operation, with all transmit antenna active, all RF chain in operation of full bandwidth and the massive MIMO is operation with maximum throughput with 64 antenna array beamforming with high gain (17.5 dB). The system will have roughly 6 dB of margin in the link budget for PDSCH. At this situation the power consumption of base station (e.g., O-RU/RRU) is very high; usually around 1000˜1500 W per RRU.

As previously mentioned, various power efficiency schemes may be implemented in Low Network Traffic Mode. A Low Network Traffic Mode may occur during nighttime, where network traffic may drop to as low as 5% of designed network capacity. If a base station (e.g., O-RU/O-DU) continues to operate the same way as the daytime, it leads to a waste of energy.

To operate with power efficiency, e.g., during low network traffic times, include implementing the following:
1) turn off some of the carriers or reduce the bandwidth
2) turn off some of the antenna RF chains
3) change the MIMO configuration.
4) change the average power of transmission of some or all the Tx RF chains.

These actions, implemented individually, e.g., by one or more base stations, may or may not achieve the expected power efficiency like proportional to the network traffic (5%). That is, they can achieve expected power efficiency if at least two of them are implemented. These actions, and other actions described herein may be dynamically implemented, and may be continually and/or dynamically adjusted responsive to repeated or continually measured/determined traffic conditions at the base station. A low traffic condition may be a condition in which measured traffic condition, e.g., network traffic, may be less than or equal to a predefined threshold value, e.g., a predefined network traffic value. Another threshold value used to ascertain a low traffic condition may be a determined amount of active devices operating in the network or wireless communication system. Other factors may be considered for determining a present low traffic condition, such as for example, a time of day.

According to at least one aspects, the power efficiency actions described below may be implemented during low network traffic can include:

One action that can be implemented for a base station to turn or switch off some of the carriers, or reduce the bandwidth. For example, referring to the RF circuitry 406 of FIG. 4, or parts thereof may be switched off. This will save some of the RF chain power. However, since all antenna elements are still on, all the chain still consumes a majority of power even they have reduced transmission power. The power savings of overall system can be limited. However, in this case coverage is not impacted as the TX power density is not impacted if the transmission power scale at the same level as the bandwidth scale down.

Carriers can be turned off so that bandwidth is reduced from 100 MHz to 20 MHz, the Tx Power will accordingly be reduced from 100 W to 20 W on 20 MHz. As a result, there is no coverage issue. Turning off a carrier can include turning off one or more circuitries or devices of a RF chain.

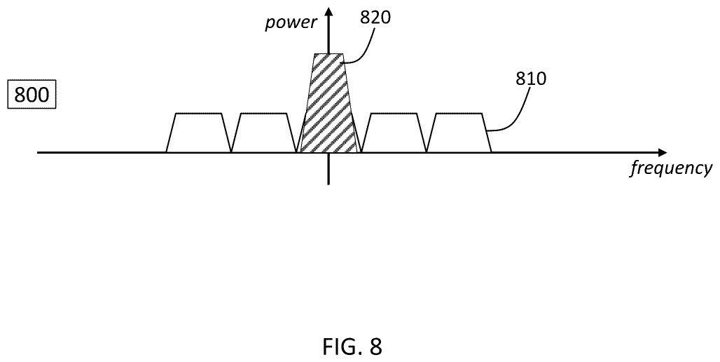

FIG. 8 shows a graph 800 of plots of transmission bandwidth versus power for transmission of a base station implementing a power saving or power efficiency scheme. The plot 810 shows the transmission during normal times, which has a wider bandwidth (over greater frequency range). The plot 820 shows the transmission after the power efficiency scheme, as such it is over a smaller bandwidth (smaller frequency range) but the power for is greater for that more limited bandwidth.

Another action that can be implemented for power efficiency (e.g., during low network traffic mode or times) is turn off some of the antenna elements in the massive MIMO antenna array. Such an action can realize power savings because it requires the corresponding RF chain to be turned off and consume no power. However, because there are less total TX transmission power (linear to the total active RF Chain), as well as less antenna results in less Downlink beamforming gain (could be estimated as 3 dB every time the antenna elements are halved). Further, the TX power density and the MIMO beamforming gain can both be negatively affected resulting in reduced coverage.

In one example, seven-eighths (⅞) of a 64 antenna elements of an antenna array can be turned off, e.g., in a base station, leaving only 8 antennas turned. Therefore, the total power would only be one-eighth (⅛) which is a 9 dB loss and the MIMO antenna beamforming gain also realize an approximately a9 dB loss. This would result in −18 dB in link budget and it will not be enough for 500 m radius coverage.

Another action that can also be implemented for power efficiency would be to change the MIMO configuration. For example, if the MIMO configuration changes from 64×8 antenna elements active to 64×1 antenna elements active, RF chains are turned off but this would not yield much power savings. However, if a (massive) MIMO configuration is changed from 64×1 elements active to 8×1, there is power savings, but also some MIMO beamforming loss.

Another action that can also be implemented for power efficiency would be to change the average power of transmission of some or all the Tx RF chains. It is noted that if they were a reduction in the power level in only the RX chains then the RF chains of all antenna elements would still active and thus the majority of power would be used and hence there would be limited power saving further not be saved not be saved.

It also noted that if average power is reduced, the transmitted power density is also reduced, it would negatively affect the transmission power. For example, if all antennas reduce the power to ⅛, which will loss 9 dB in TX power density, the link budget will not be enough for 500 m radius, while the power saving is also very limited.

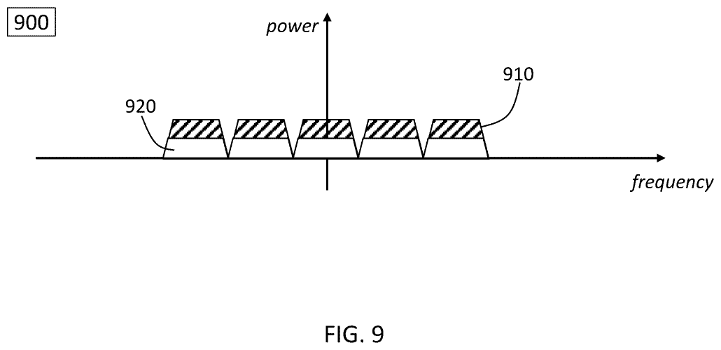

FIG. 9 shows a graph 900 of plots of transmission bandwidth versus power for transmission of a base station implementing a power saving or power efficiency scheme. In this case, the plots are representative of average transmission power over frequency for normal operation (e.g., massive MIMO) 910 and for a power efficiency scheme in which the average transmission power is reduced 920.

The combination of the above described power efficiency solutions or schemes, e.g., in one or more base station, can allow for maintaining a given link budget and meet the 500 m coverage requirements. In one example, for a single cell (e.g., massive MIMO) case, the (transmission) bandwidth can be reduced to one-fifth ( 1/50, and three-fourths (¾) of the antennas can be turned off to leave only sixteen antennas (16) antenna RF chains active. In such a case, the total power transmission can reduce to 12.5 W on 20 MHz. IN such a case, the MIMO beamforming loss will be ˜6 dB.

Further, the link budget loss would be: −6 dB−6 dB+7 dB=−5 dB. This link budget leaves a 6 dB margin, hence the coverage is still acceptable. The table below shows the results for the combined power efficiency scheme for a single cell MIMO.

| Cell radius | 500 m |
|---|---|
| Link budget, dBm | −90.21 PASS |
| Reception sensitivity | −91.46 |

In another example, a combination of power efficiencies schemes described herein may be applied to a multi-cell join massive MIMO situation. The combination of power efficiency schemes includes a reduction of (transmission) bandwidth by one-fifth (⅕) and turning off seven-eighths of the antennas used (⅞), which can, for example, leave only 8 active antenna RF chains. As a result, the total power transmission can reduce to 6.25 W on 20 MHz. In such a case, the MIMO beamforming loss can be ˜9 dB.

However, for the edge of cell where we can be other cells (e.g., two other cells) with the same adaptive power scheme helping, there would be three sectors each with 8 antennas active to do a joint downlink transmission. The joint processing would be 10*log 10(3) and the total power is also 3×, brings another 10*log 10(3) gain in link budget.

The link budget loss would be: −9 dB−9 dB+7 dB+4.77 dB+4.77 dB=−1.46 dB. Since we have 6 dB margin, the coverage is acceptable, which is an improvement over the single cell case. The table below shows the results for the combined power efficiency scheme for a multi cell massive MIMO.

| Cell radius | 500 m |
|---|---|
| Link budget, dBm | −86.67 PASS |
| Reception sensitivity | −91.46 |

Aspects of the present disclosure implementations of the scalable efficiency idea below where significant power savings are realized by switching off TX paths when DL throughput demand is low. It is noted that depending on the required bandwidth in downlink transmission, antennas are switched off to save power by the virtue of switching off the power amplifiers and associated analogue and mixed signal paths. For the uplink direction, all the antennas remain on (e.g., in the receiver path all receive antenna chains with, for example, low noise amplifiers (LNAs) and other mixed signal components) remaining on or active.

Further, in time-division duplex, e.g., for massive-MIMOs, this different antenna switching configuration can perfectly overlap with the existing uplink-downlink (UL-DL) switching times, except that when switching to DL, only selected TX paths are switched to.

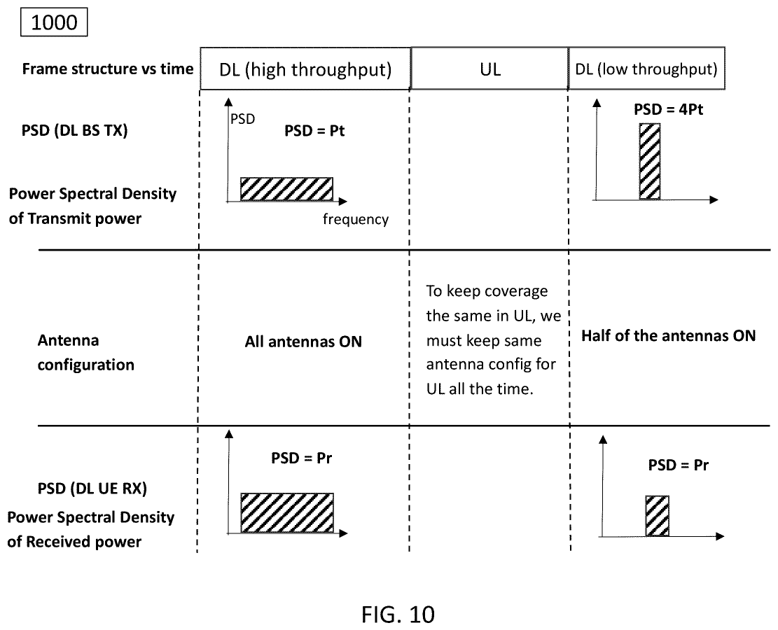

FIG. 10 shows a table 1000 where the DL throughput requirement switches from Full band where all antennas active to ¼th of the band. As indicated in FIG. 10, a base station (BS) can maintain the same TX power per TX antenna by increasing the TX PSD by 6 dB. This allows for the switching off, e.g., of half the antennas. By doing, the same received PSD at UE can be maintained despite a 6 dB coherent beamforming gain loss, and also the same coverage for DL can also be maintained.

As indicated in the table 1000, in uplink direction, all the antennas are kept on or are active regardless of the throughput demand as this is required to maintain the same coverage.

Generally, a large portion of cellular radio (radio unit—RU) power consumption, ˜70% or more, is attributed to the DL (with the power consumption of the PAs dominating). Hence the above scheme can potentially save ˜35% of overall power consumption of the radio.

It should be noted that one or more of the features of any of the examples, aspects, or embodiments above may be combined with any one of the other examples.

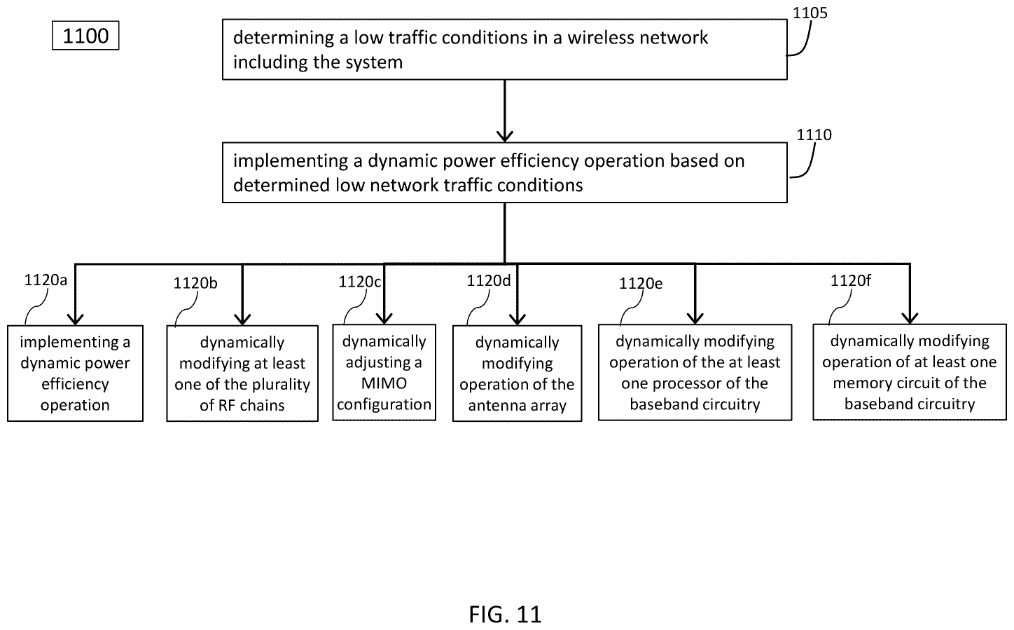

FIG. 11 shows a method 1100 according to at least one aspect of the present disclosure. The method 1100 can be implemented in and for a system (e.g., implemented by a base station or access point) with multiple antenna elements of an antenna array to be used to for transmitting according to a multiple-input multiple-output (MIMO) scheme. At 1105, the method 100 includes determining a current low traffic condition state in a wireless communication network. At 1110, the method 1100 includes implementing a dynamic power efficiency operation based on the determined current network traffic conditions.

For the method 1100, implementing a dynamic power efficiency operation includes
at 1120a, implementing a dynamic power efficiency operation;
at 1120b, dynamically modifying at least one of the plurality of RF chains of the base station;
at 1120c, dynamically adjusting a MIMO configuration; of the base station;
at 1120d, dynamically modifying operation of the antenna array;
at 1120e, dynamically modifying operation of the at least one processor a baseband circuitry of the base station/AP;
at 1120f, dynamically modifying operation of the at least one memory circuit of the baseband circuitry of the base station/AP;

While specific aspects have been described, it should be understood by those skilled in the art that various changes in form and detail may be made therein without departing from the spirit and scope of the aspects of the present disclosure. All changes which come within the meaning and range of equivalency of the claims are therefore intended to be embraced.

These processes are illustrated as a collection of blocks in a logical flow graph, which represents a sequence of operations that may be implemented in mechanics alone or a combination with hardware, software, and/or firmware. In the context of software/firmware, the blocks represent instructions stored on one or more computer-readable storage media that, when executed by one or more processors, perform the recited operations.

The term “computer-readable media” includes computer-storage media. In one embodiment, computer-readable media is non-transitory. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

The term “data” as used herein, for example in relation to “input data” or “output data”, may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The term “processor” as used herein may be understood as any kind of technological entity that allows handling of data. The data may be handled according to one or more specific functions that the processor may execute. Further, a processor as used herein may be understood as any kind of circuit, e.g., any kind of analog or digital circuit. A processor may thus be or include an analog circuit, digital circuit, mixed-signal circuit, logic circuit (e.g., a hard-wired logic circuit or a programmable logic circuit), microprocessor (for example a Complex Instruction Set Computer (CISC) processor or a Reduced Instruction Set Computer (RISC) processor), Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. A “processor” may also be a logic-implementing entity executing software, for example any kind of computer program, for example a computer program using a virtual machine code such as for example Java. A “processor” as used herein may also include any kind of cloud-based processing system that allows handling of data in a distributed manner, e.g. with a plurality of logic-implementing entities communicatively coupled with one another (e.g. over the internet) and each assigned to handling the data or part of the data. By way of illustration, an application running on a server and the server can also be a “processor”. Any other kind of implementation of the respective functions, which will be described below in further detail, may also be understood as a processor. It is understood that any two (or more) of the processors detailed herein may be realized as a single entity with equivalent functionality or the like, and conversely that any single processor detailed herein may be realized as two (or more) separate entities with equivalent functionality or the like.

The term “system” detailed herein may be understood as a set of interacting elements, the elements may be, by way of example and not of limitation, one or more physical components (e.g., processors, transmitters and/or receivers) and/or one or more digital components (e.g., code segments, instructions, protocols). Generally, the system may include one or more functions to be operated (also referred to as “operating functions”) of which each may be controlled for operating the whole system.

The term “memory” as used herein may be understood as a computer-readable medium (e.g., a non-transitory computer-readable medium), in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Furthermore, it is appreciated that registers, shift registers, processor registers, data buffers, among others, are also embraced herein by the term memory. It is also appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

The term “software” refers to any type of executable instruction, including firmware.

As used herein, a “cell” in the context of telecommunications may be understood as a sector served by a network access node (e.g., base station). A wireless network may be distributed over a plurality of cells. Accordingly, a cell may be a set of geographically co-located antennas that correspond to a particular sector of a network access node. A network access node can thus serve one or more cells (or sectors), where the cells are characterized by distinct communication channels. Furthermore, the term “cell” may be utilized to refer to any of a macro cell, micro cell, femto cell, pico cell, etc. An “inter-cell handover” may be understood as a handover from a first “cell” to a second “cell”, where the first “cell” is different from the second “cell”. “Inter-cell handovers” may be characterized as either “inter-network access node handovers” or “intra-network access node handovers”. “Inter-network access node handovers” may be understood as a handover from a first “cell” to a second “cell”, where the first “cell” is provided at a first network access node and the second “cell” is provided at a second, different, network access node. “Intra-network access node handovers” may be understood as a handover from a first “cell” to a second “cell”, where the first “cell” is provided at the same network access node as the second “cell”. A “serving cell” may be understood as a “cell” that a wireless communication device is currently connected to according to the mobile communications protocols of the associated mobile communications network standard. In case a cell is served by a mobile network access node, the cell itself may be non-stationary, e.g. may be a mobile cell.

The present disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the examples described herein. For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Exemplary Cellular Wide Area radio communication technologies that the present disclosure may utilize include, but are not limited to: Long Term Evolution (LTE), Long Term Evolution-Advanced (LTE-A), 5th Generation (5G) communication systems, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSDPA Plus (HSDPA+), HSUPA (High-Speed Uplink Packet Access), HSUPA Plus (HSUPA+), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4^{th} Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 12), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (LAA), MuLTEfire, UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Zigbee, Bluetooth®, Wireless Gigabit Alliance (WiGig) standard, Worldwide Interoperability for Microwave Access (WiMax) (e.g., according to an IEEE 802.16 radio communication standard, e.g., WiMax fixed or WiMax mobile), mmWave standards in general (wireless systems operating at 10-90 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication arrangements such as Intelligent-Transport-Systems, etc. Cellular Wide Area radio communication technologies also include “small cells” of such technologies, such as microcells, femtocells, and picocells. Cellular Wide Area radio communication technologies may be generally referred to herein as “cellular” communication technologies. As used herein, a first radio communication technology may be different from a second radio communication technology if the first and second radio communication technologies are based on different communication standards.

The term “5G” as used herein refers to wireless technologies as provided by the 3GPP and International Telecommunication Union (ITU) standards. This may include spectral use overlapping with the existing LTE frequency range (e.g., 600 MHz to 6 GHZ) and also include spectral use in the millimeter wave bands (e.g., 24-86 GHz). Also, the terms 5G, New Radio (NR), or 5G NR may be used interchangeably. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum.

The present disclosure may use such radio communication technologies according to various spectrum management schemes, including, but not limited to, dedicated licensed spectrum, unlicensed spectrum, (licensed) shared spectrum (such as LSA, “Licensed Shared Access,” in 2.3-2.4 GHz, 3.4-3.6 GHz, 3.6-3.8 GHz and further frequencies and SAS, “Spectrum Access System,” in 3.55-3.7 GHz and further frequencies), and may use various spectrum bands including, but not limited to, IMT (International Mobile Telecommunications) spectrum (including 450-470 MHZ, 790-960 MHz, 1710-2025 MHz, 2110-2200 MHz, 2300-2400 MHZ, 2500-2690 MHZ, 698-790 MHz, 610-790 MHz, 3400-3600 MHZ, etc., where some bands may be limited to specific region(s) and/or countries), IMT-advanced spectrum, IMT-2020 spectrum (expected to include 3600-3800 MHZ, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHZ, 31-31.3 GHZ, 37-38.6 GHz, 38.6-40 GHz, 42-42.5 GHZ, 57-64 GHZ, 64-71 GHz, 71-76 GHz, 81-86 GHz and 92-94 GHZ, etc.), the ITS (Intelligent Transport Systems) band of 5.9 GHZ (typically 5.85-5.925 GHZ) and 63-64 GHZ, bands currently allocated to WiGig such as WiGig Band 1 (57.24-59.40 GHz), WiGig Band 2 (59.40-61.56 GHz) and WiGig Band 3 (61.56-63.72 GHZ) and WiGig Band 4 (63.72-65.88 GHZ), the 70.2 GHz-71 GHz band, any band between 65.88 GHz and 71 GHz, bands currently allocated to automotive radar applications such as 76-81 GHZ, and future bands including 94-300 GHz and above. Furthermore, aspects described herein can also employ radio communication technologies on a secondary basis on bands such as the TV White Space bands (typically below 790 MHZ) where in particular the 400 MHz and 700 MHz bands are prospective candidates. Besides cellular applications, specific applications for vertical markets may be addressed such as PMSE (Program Making and Special Events), medical, health, surgery, automotive, low-latency, drones, etc. applications. Furthermore, aspects described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. Aspects described herein can also use radio communication technologies with different Single Carrier or OFDM flavors (CP-OFDM, SC-FDMA, SC-OFDM, filter bank-based multicarrier (FBMC), OFDMA, etc.) and in particular 3GPP NR (New Radio), which can include allocating the OFDM carrier data bit vectors to the corresponding symbol resources.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor may transmit or receive data over a software-level connection with another processor in the form of radio signals, where radio-layer components carry out the physical transmission and reception, such as radio frequency (RF) transceivers and antennas, and the processors perform the logical transmission and reception over the software-level connection.

The term “communicate” encompasses one or both of transmitting and receiving, i.e., unidirectional or bidirectional communication in one or both of the incoming and outgoing directions. In general, the term “communicate” may include the exchange of data, e.g., unidirectional or bidirectional exchange in one or both of the incoming and outgoing directions.

The term “calculate” encompasses both ‘direct’ calculations via a mathematical expression/formula/relationship and ‘indirect’ calculations via lookup or hash tables and other array indexing or searching operations.

As utilized herein, the term “derived from” designates being obtained directly or indirectly from a specific source. Accordingly, data derived from a source includes data obtained directly from the source or indirectly from the source, i.e. through one or more secondary agents.

The word “exemplary” is used herein to mean “serving as an example, instance, or illustration”. Any embodiment or design described herein as “exemplary” is not necessarily to be construed as preferred or advantageous over other embodiments or designs.

The words “plural” and “multiple” in the description and the claims, if any, are used to expressly refer to a quantity greater than one. Accordingly, any phrases explicitly invoking the aforementioned words (e.g. “a plurality of [objects]”, “multiple [objects]”) referring to a quantity of objects is intended to expressly refer more than one of the said objects. For instance, the phrase “a plurality” may be understood to include a numerical quantity greater than or equal to two (e.g., two, three, four, five, [ . . . ], etc.). The terms “group”, “set”, “collection”, “series”, “sequence”, “grouping”, “selection”, etc., and the like in the description and in the claims, if any, are used to refer to a quantity equal to or greater than one, i.e. one or more. Accordingly, the phrases “a group of [objects]”, “a set of [objects]”, “a collection of [objects]”, “a series of [objects]”, “a sequence of [objects]”, “a grouping of [objects]”, “a selection of [objects]”, “[object] group”, “[object] set”, “[object] collection”, “[object] series”, “[object] sequence”, “[object] grouping”, “[object] selection”, etc., used herein in relation to a quantity of objects is intended to refer to a quantity of one or more of said objects. It is appreciated that unless directly referred to with an explicitly stated plural quantity (e.g. “two [objects]”, “three of the [objects]”, “ten or more [objects]”, “at least four [objects]”, etc.) or express use of the words “plural”, “multiple”, or similar phrases, references to quantities of objects are intended to refer to one or more of said objects.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

As used herein, a signal (e.g., data) that is “indicative of” a value or other information may be a digital or analog signal that encodes or otherwise communicates the value or other information in a manner that can be decoded by and/or cause a responsive action in a component receiving the signal. The signal may be stored or buffered in computer readable storage medium prior to its receipt by the receiving component and the receiving component may retrieve the signal from the storage medium. Further, a “value” that is “indicative of” some quantity, state, or parameter may be physically embodied as a digital signal, an analog signal, or stored bits that encode or otherwise communicate the value.

Any vector and/or matrix notation utilized herein is exemplary in nature and is employed solely for purposes of explanation. Accordingly, aspects of this disclosure accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

In the following some examples are described, which relate to what is described herein and shown in the figures.

Example 1 is an apparatus for a base station configured to operate in a massive multiple-input multiple-output (MIMO), including: an antenna array comprising a plurality of antenna elements; radio frequency (RF) circuitry including a plurality of radio frequency (RF) chains coupled to a plurality of antennas from an antenna array and are configured to create radio frequency signals from baseband signals; and baseband circuitry including at least one processor and coupled to the RF circuitry, the base band circuitry configured to cause the apparatus to implement a dynamic power efficiency operation based on current network traffic requirements.

Example 2 is the subject matter of Example 1, wherein to implement the dynamic power efficiency scheme may include the baseband circuitry to cause the apparatus to implement a sidelobe suppression scheme including the baseband circuitry configured to: define a plurality of sub-arrays of antenna elements from the antenna array, wherein each of the plurality of sub-arrays overlaps with one other sub-array of the plurality of sub-arrays; and apply a spatial windowing function to signals for each of the plurality of sub-arrays so that each transmission by the plurality of sub-arrays has tapered transmit power profile.

Example 3 is the subject matter of Example 2, wherein in response to applying the spatial windowing function, each of the plurality of sub-arrays are configured to transmit with at substantially same power level.

Example 4 is the subject matter of Example 2 or 3, wherein in response to applying the spatial windowing function, a transmit power profile power spectral density from the antenna array, as a whole, is substantially flat.

Example 5 is the subject matter of any of Examples 1 to 4, wherein to cause the apparatus to implement the dynamic power efficiency scheme may include the baseband circuitry to cause one or more of the following: dynamically modify at least one of the plurality of RF chains; dynamically adjust a MIMO configuration; dynamically modify operation of the antenna array; dynamically change modifying operation an operating frequency of the at least one processor of the baseband circuitry; and/or dynamically modify operation of at least one memory circuit of the baseband circuitry.

Example 6 is the subject matter of Example 5, wherein to dynamically modify at least one of the RF chains may include to dynamically reduce an operational bandwidth from a first bandwidth to a second bandwidth, which is lower than the first bandwidth.

Example 7 is the subject matter of Example 6, wherein to dynamically reduce the operational bandwidth may include turning off one or more carrier signals in at the at least one of the RF chains.

Example 8 is the subject matter of Example 6 or 7, wherein the first bandwidth can be 40 MHz, 60 MHz, 80 MHz, or 100 MHZ, and wherein the second bandwidth can be 20 MHz.

Example 9 is the subject matter of any of Examples 5 to 8, wherein to dynamically modify at least one of the plurality of RF chains may include to dynamically change an average transmission power of at least one of the plurality of RF chains.

Example 10 is the subject matter of any of Examples 5 to 9, wherein to dynamically modify operation of the antenna array may include to dynamically turn off one or more of the antenna elements.

Example 11 is the subject matter of Example 10, wherein to dynamically turn off one or more of the antennas elements may further include to dynamically turn of one or more components of a RF chain associated with the one or more antenna elements to be turned off.

Example 12 is the subject matter of any of Examples 5 to 11, wherein to dynamically adjust the MIMO configuration may include to cause the apparatus to switch from operating according to a single-cell massive MIMO scheme to operating according to a multi-cell joint massive MIMO processing scheme.

Example 13 is the subject matter of any of Examples 5 to 12, wherein to dynamically adjust a MIMO configuration may include to cause the apparatus to switch from operating according to a multi-cell joint massive MIMO processing scheme to operating according to a single-cell massive MIMO scheme.

Example 14 is the subject matter of any of Examples 5 to 13, wherein to dynamically adjust the MIMO configuration may include to operate a subset of antenna array that includes less than a total number of the plurality of antenna elements of the antenna array.

Example 15 is the subject matter of any of Examples 5 to 14, wherein dynamically modifying operation of the at least one processor of the baseband circuitry can include to dynamically lower an operating frequency of the at least one processor.

Example 16 is the subject matter of any of Examples 5 to 15, wherein the at least one memory circuit can include a plurality of memory circuits, and wherein dynamically modifying operation of the at least one memory circuit of the baseband circuitry can include dynamically turning off one or more of the plurality of memory circuits.

Example 17 is the subject matter of any of Examples 5 to 16, wherein the at least one processor can include a plurality of processor cores, and wherein dynamically modifying operation of the at least one processor of the baseband circuitry can include dynamically turning off one or more of the processor cores.

Example 18 is the subject matter of any of Examples 5 to 17, wherein the antenna array may be a one-dimensional (1D) array of antenna elements.

Example 19 is the subject matter of any of Examples 1 to 18, wherein the antenna array may be a two-dimensional (2D) array of antenna elements.

Example 20 is the subject matter of any of Examples 1 to 19, wherein the baseband circuitry can be configured to dynamically implement the power efficiency scheme so that a power density level in a coverage area and received signal sensitivity in an uplink maintains a current service level.

Example 21 is the subject matter of any of Examples 1 to 20, wherein the baseband circuitry is configured to implement the dynamic power efficiency scheme can include the baseband circuitry configured to: determine the apparatus is operating in an idle mode or low traffic mode, determine a current link budget for current operation, determine a link budget the dynamic power efficiency scheme, and implement the dynamic power efficiency scheme if the link budget for the dynamic power efficiency scheme is less than the current link budget.

Example 1A is a method for a base station with multiple antenna elements of antenna array to be used to for transmitting according to a multiple-input multiple-output (MIMO) scheme, the method including: determining a current low traffic conditions in a wireless communication network; and implementing a dynamic power efficiency operation based on determined current network traffic conditions.

Example 2A is the subject matter of Example 1A, wherein implementing the dynamic power efficient operation may include implementing a sidelobe suppression scheme including: defining a plurality of sub-arrays of antenna elements from the antenna array, wherein each of the plurality of sub-arrays overlaps with one other sub-array of the plurality of sub-arrays; and applying a spatial windowing function to signals for each of the plurality of sub-arrays so that each transmission by the plurality of sub-arrays has tapered transmit power profile.

Example 3A is the subject matter of Example 2A, wherein in response to applying the spatial windowing function, each of the plurality of sub-arrays may be configured to transmit with at substantially same power level and a transmit power profile from the antenna array, as a whole, is substantially flat.

Example 4A is the subject matter of any of Examples 1A to 3A, wherein implementing the dynamic power efficient operation may include to perform one or more of the following: dynamically modifying at least one of the plurality of RF chains of the base station; dynamically adjusting a MIMO configuration; of the base station; dynamically modifying operation of the antenna array; dynamically changing modifying operation of the at least one processor of a baseband circuitry of the base station; and/or dynamically modify operation of at least one memory circuit of the base station.

Example 5A is the subject matter of Example 4A, wherein dynamically modifying at least one RF chain of the plurality of RF chains may include to dynamically reduce an operational bandwidth of the base station from a first bandwidth to a second bandwidth, which is lower than the first bandwidth.

Example 6A is the subject matter of Example 5A, wherein dynamically reducing the operational bandwidth of the base station may include turning off one or more carrier signals in at the at least one RF chain of the plurality of RF chains.

Example 7A is the subject matter of Example 5A or 6A, wherein the first bandwidth may be 40 MHz, 60 MHz, 80 MHz, or 100 MHz, and wherein the second bandwidth may be 20 MHz.

Example 8A is the subject matter of any of Examples 4A to 7A, wherein dynamically modifying at least one RF chain of the plurality of RF chains may include to dynamically change an average transmission power of at least one RF chain of the plurality of RF chains.

Example 9A is the subject matter of any of Examples 4A to 8A, wherein dynamically modifying operation of the antenna array may include dynamically turning off one or more of the antenna elements.

Example 10A is the subject matter of Example 9A, wherein dynamically turning off one or more of the antennas elements may further include dynamically turning of one or more components of a RF chain associated with the one or more antenna elements to be turned off.

Example 11A is the subject matter of any of Examples 4A to 10A, wherein dynamically adjusting the MIMO configuration may include switching from operating according to a single-cell massive MIMO scheme to operating according to a multi-cell joint massive MIMO processing scheme.

Example 12A is the subject matter of any of Examples 4A to 11A, wherein dynamically adjusting a MIMO configuration may include to cause the apparatus to switch from operating according to a multi-cell joint massive MIMO processing scheme to operating according to a single-cell massive MIMO scheme.

Example 13A is the subject matter of any of Examples 4A to 12A, wherein to dynamically adjust the MIMO configuration may include operating a subset of the antenna array that is less than a total number of the plurality of antenna elements of the antenna array.

Example 14A is the subject matter of any of Examples 4A to 13A, wherein dynamically modifying operation of the at least one processor of the baseband circuitry comprises dynamically lowering an operating frequency of the at least one processor.

Example 15A is the subject matter of any of Examples 4A to 14A, wherein the at least one memory circuit may include a plurality of memory circuits, and wherein dynamically modifying operation of the at least one memory circuit of the baseband circuitry may include dynamically turning off one or more of the plurality of memory circuits.

Example 16A is the subject matter of any of Examples 4A to 15A, wherein the at least one processor may include a plurality of processor cores, and wherein dynamically modifying operation of the at least one processor of the baseband circuitry may include dynamically turning off one or more of the processor cores.

Example 17A is the subject matter of any of Examples 1A to 16A, wherein the antenna array may be a one-dimensional (1D) array of antenna elements.

Example 18A is the subject matter of any of Examples 1A to 17A, wherein the antenna array may be a two-dimensional (2D) array of antenna elements.

Example 19A is the subject matter of any of Examples 1A to 18A, wherein implementing the dynamic power efficiency scheme may include baseband circuitry implementing the dynamic power efficiency scheme.

Example 20A is the subject matter of Example 19A, wherein the baseband circuitry implementing the dynamic power efficiency scheme may include implementing the dynamic power efficiency scheme so that a power density level in a coverage area and received signal sensitivity in an uplink maintains a current service level.

Example 21A is the subject matter of any of Examples 19A to 20A, wherein the baseband circuitry implementing the dynamic power efficiency scheme can include the baseband circuitry performing: determining the apparatus is operating in an idle mode or low traffic mode wherein an idle mode or low traffic mode occurs when network traffic falls below a predefined threshold, determining a current link budget for current operation, determine a link budget for the dynamic power efficiency scheme, and implementing the dynamic power efficiency scheme in response to determining the link budget for the dynamic power efficiency scheme is less than the current link budget.

Example 1B is one or more non-transitory computer-readable storage media (NTCRSM) comprising instructions, wherein execution of the instructions by one or more processors of a base station is to cause the base station to: determine current traffic conditions in a wireless network including the base station; and implement a dynamic power efficiency scheme based on determining low traffic for the current network traffic conditions.

Example 2B is the subject matter of Example 1B, wherein to implement the dynamic power efficiency scheme may include to implement a sidelobe suppression scheme.

Example 3B is the subject matter of Example 2, wherein to implement the dynamic power efficiency scheme may include to: define a plurality of sub-arrays of antenna elements from the antenna array, wherein each of the plurality of sub-arrays overlaps with one other sub-array of the plurality of sub-arrays; and apply a spatial windowing function to signals for each of the plurality of sub-arrays so that each transmission by the plurality of sub-arrays has tapered transmit power profile.

Example 4B is the subject matter of Example 3, wherein to apply the spatial windowing function comprises to apply the spatial windowing function so that each of the plurality of sub-arrays are configured to transmit with substantially a same power level and so that a transmit power profile from the antenna array as a whole is substantially flat.

Example 5B is the subject matter of Example 1 or 2, wherein to implement the dynamic power efficient scheme comprises to cause the base station to perform one or more of the following: dynamically modify at least one of a plurality of RF chains of the base station; dynamically adjust a MIMO configuration of the base station; dynamically modify operation of an antenna array of the base station; dynamically modify operation of at least one processor of the baseband circuitry of the base station; and/or; dynamically modify operation of at least one memory circuit of the baseband circuitry.

Example 6B is the subject matter of Example 5B, wherein to dynamically modify at least one of the RF chains comprises to dynamically reduce an operational bandwidth from a first bandwidth to a second bandwidth, which is lower than the first bandwidth.

Example 7B is the subject matter of Example 6B, wherein to dynamically reduce the operational bandwidth may include turning off one or more carrier signals in at the at least one of the RF chains.

Example 8B is the subject matter of Example 6B or 7B, wherein the first bandwidth can be 40 MHz, 60 MHz, 80 MHz, or 100 MHz, and wherein the second bandwidth can be 20 MHz.

Example 9B is the subject matter of any of Examples 5B to 8B, wherein to dynamically modify at least one of the plurality of RF chains may include to dynamically change an average transmission power of at least one of the plurality of RF chains.

Example 10B is the subject matter of any of Examples 5B to 9B, wherein to dynamically modify operation of the antenna array may include to dynamically turn off one or more of the antenna elements.

Example 11B is the subject matter of Example 10B, wherein to dynamically turn off one or more of the antennas elements may further include to dynamically turn of one or more components of a RF chain associated with the one or more antenna elements to be turned off.

Example 12B is the subject matter of any of Examples 5B to 11B, wherein to dynamically adjust the MIMO configuration may include to cause the apparatus to switch from operating according to a single-cell massive MIMO scheme to operating according to a multi-cell joint massive MIMO processing scheme.

Example 13B is the subject matter of any of Examples 5B to 12B, wherein to dynamically adjust a MIMO configuration may include to cause the apparatus to switch from operating according to a multi-cell joint massive MIMO processing scheme to operating according to a single-cell massive MIMO scheme.

Example 14B is the subject matter of any of Examples 5B to 13B, wherein to dynamically adjust the MIMO configuration may include to operate a subset of antenna array that includes less than a total number of the plurality of antenna elements of the antenna array.

Example 15B is the subject matter of any of Examples 1B to 14B, wherein to dynamically modify operation of the at least one processor of the baseband circuitry comprises to dynamically lower an operating frequency of the at least one processor.

Example 16B is the subject matter of any of Examples 5B to 15B, wherein the at least one memory circuit may include a plurality of memory circuits, and wherein to dynamically modify operation of the at least one memory circuit of the baseband circuitry may include to dynamically turn off one or more of the plurality of memory circuits.

Example 17B is the subject matter of any of Examples 5B to 16B, wherein the at least one processor may include a plurality of processor cores, and wherein to dynamically modify operation of the at least one processor of the baseband circuitry may include to dynamically turn off one or more of the processor cores.

Example 18B is the subject matter of any of Examples 1B to 17B, wherein the antenna array may be a one-dimensional (1D) array of antenna elements.

Example 19B is the subject matter of any of Examples 1B to 18B, wherein the antenna array may be a two-dimensional (2D) array of antenna elements.

Example 20B is the subject matter of any of Examples 1B to 19B, wherein the baseband circuitry may be configured to dynamically implement the power efficiency scheme so that a power density level in a coverage area and received signal sensitivity in an uplink maintains a current service level.

Example 21B is the subject matter of any of Examples 1B to 20B, wherein to implement the dynamic power efficiency scheme may further include to: determine the apparatus is operating in an idle mode or low traffic mode, wherein an idle mode or low traffic mode occurs when network traffic falls below a predefined threshold, determine a current link budget for current operation, determine a link budget the dynamic power efficiency scheme, and implement the dynamic power efficiency scheme if the link budget for the dynamic power efficiency scheme is less than the current link budget.

Example 1C is an apparatus for a base station configured to operate in a massive multiple-input multiple-output (MIMO), including: an antenna array comprising a plurality of antenna elements; radio frequency circuitry comprising a plurality of radio frequency (RF) chains coupled to a plurality of antennas from an antenna array and are configured to create radio frequency signals from baseband signals; and means for causing the apparatus to implement a dynamic power efficiency operation based on current network traffic requirements.

Example 2C is the subject matter of Example 1C, wherein the means for causing the apparatus to implement the dynamic power efficiency scheme may include means for causing the apparatus to implement a sidelobe suppression scheme.

Example 3C is the subject matter of Example 2C, wherein the means for causing the apparatus to implement the sidelobe suppression scheme may include: means for defining a plurality of sub-arrays of antenna elements from the antenna array, wherein each of the plurality of sub-arrays overlaps with one other sub-array of the plurality of sub-arrays; and means for applying a spatial windowing function to signals for each of the plurality of sub-arrays so that each transmission by the plurality of sub-arrays has tapered transmit power profile.

Example 4C is the subject matter of any of Examples 1C to 3C, wherein the means for causing the apparatus to implement the dynamic power efficiency scheme may include to perform one more than one of the following: means for dynamically modifying at least one of the plurality of RF chains; means for dynamically adjusting a MIMO configuration; means for dynamically modifying operation of the antenna array; means for dynamically modifying operation of the at least one processor of a baseband circuitry of the apparatus; and/or means for dynamically modifying operation of at least one memory circuit of the baseband circuitry of the apparatus.

Example 5C is the subject matter of Example 4C, wherein the means for dynamically modifying at least one of the RF chains may include means for dynamically reducing an operational bandwidth from a first bandwidth to a second bandwidth, which is lower than the first bandwidth.

Example 6C is the subject matter of Example 5C, wherein the means for dynamically reducing the operational bandwidth may include means for turning off one or more carrier signals in at the at least one of the RF chains.

Example 7C is the subject matter of Example 5C or 6C, wherein the first bandwidth may be 40 MHz, 60 MHz, 80 MHz, or 100 MHz, and wherein the second bandwidth may be 20 MHz.

Example 8C is the subject matter of any of Examples 4C to 7C, wherein the means for dynamically modifying at least one of the plurality of RF chains may include means for dynamically changing an average transmission power of at least one of the plurality of RF chains.

Example 9C is the subject matter of any of Examples 4C to 8C, wherein the means for dynamically modifying operation of the antenna array may include means for dynamically turning off one or more of the antenna elements.

Example 10C is the subject matter of Example 9C, wherein the means for dynamically turn off one or more of the antennas elements further may include means for dynamically turning of one or more components of a RF chain associated with the one or more antenna elements to be turned off.

Example 11C is the subject matter of any of Examples 4C to 10C, wherein the means for dynamically adjusting the MIMO configuration may include means for switching from operating according to a single-cell massive MIMO scheme to operating according to a multi-cell joint massive MIMO processing scheme.

Example 12C is the subject matter of any of Examples 4C to 11C, wherein the means for dynamically adjusting a MIMO configuration may include means for switching from operating according to a multi-cell joint massive MIMO processing scheme to operating according to a single-cell massive MIMO scheme.

Example 13C is the subject matter of any of Examples 4C to 12C, wherein the means for dynamically adjusting the MIMO configuration may include means for operating a subset of antenna array that includes less than a total number of the plurality of antenna elements of the antenna array.

Example 14C is the subject matter of any of Examples 1C to 13C, wherein the means for dynamically modifying operation of the at least one processor of the baseband circuitry may include means for dynamically lowering an operating frequency of the at least one processor.

Example 15C is the subject matter of any of Examples 1C to 14C, wherein the at least one memory circuit may include a plurality of memory circuits, and wherein the means for dynamically modifying operation of the at least one memory circuit of the baseband circuitry may include means for dynamically turning off one or more of the plurality of memory circuits.

Example 16C is the subject matter of any of Examples 1C to 15C, wherein the at least one processor may include a plurality of processor cores, and wherein the means for dynamically modifying operation of the at least one processor of the baseband circuitry may include means for dynamically turning off one or more of the processor cores.

Example 17C is the subject matter of any of Examples 1C to 16C, wherein the antenna array may be a one-dimensional (1D) array of antenna elements.

Example 18C is the subject matter of any of Examples 1C to 17C, wherein the antenna array may be a two-dimensional (2D) array of antenna elements.

Example 19C is the subject matter of any of Examples 1C to 18C, wherein the means for dynamically implementing the power efficiency scheme may include means for dynamically implementing the power efficiency scheme so that a power density level in a coverage area and received signal sensitivity in an uplink maintains a current service level.

Example 20C is the subject matter of any of Examples 1C to 19C, wherein the means for implementing the dynamic power efficiency scheme may include: means for determining the apparatus is operating in an idle mode or low traffic mode, means for determining a current link budget for current operation, means for determining a link budget the dynamic power efficiency scheme, and means for implementing the dynamic power efficiency scheme if the link budget for the dynamic power efficiency scheme is less than the current link budget.

While the above descriptions and connected figures may depict electronic device components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. An apparatus for a base station configured to operate in a massive multiple-input multiple-output (MIMO), comprising:
an antenna array comprising a plurality of antenna elements;
radio frequency circuitry comprising a plurality of radio frequency (RF) chains coupled to a plurality of antennas from an antenna array and are configured to create radio frequency signals from baseband signals; and
baseband circuitry comprising at least one processor and coupled to the RF circuitry, the baseband circuitry configured to cause the apparatus to implement a dynamic power efficiency scheme based on current network traffic requirements.

2. The apparatus of claim 1,
wherein to implement the dynamic power efficiency scheme comprises the baseband circuitry to cause the apparatus to implement a sidelobe suppression scheme comprising the baseband circuitry configured to:
define a plurality of sub-arrays of antenna elements from the antenna array, wherein each of the plurality of sub-arrays overlaps with one other sub-array of the plurality of sub-arrays; and
apply a spatial windowing function to signals for each of the plurality of sub-arrays so that each transmission by the plurality of sub-arrays has tapered transmit power profile.

3. The apparatus of claim 2,
wherein in response to applying the spatial windowing function, each of the plurality of sub-arrays are configured to transmit with at substantially same power level.

4. The apparatus of claim 2,
wherein in response to applying the spatial windowing function, a transmit power profile from the antenna array, as a whole, is substantially flat.

5. The apparatus of claim 1,
wherein to cause the apparatus to implement the dynamic power efficiency scheme comprises the baseband circuitry to perform one or more of the following:
dynamically modify at least one of the plurality of RF chains;
dynamically adjust a MIMO configuration;
dynamically modify operation of the antenna array;
dynamically modify operation of the at least one processor of the baseband circuitry; and/or
dynamically modify operation of at least one memory circuit of the baseband circuitry.

6. The apparatus of claim 5,
wherein to dynamically modify at least one of the RF chains comprises to dynamically reduce an operational bandwidth from a first bandwidth to a second bandwidth, which is lower than the first bandwidth.

7. The apparatus of claim 6,
wherein to dynamically reduce the operational bandwidth comprises turning off one or more carrier signals in at the at least one of the RF chains.

8. The apparatus of claim 5,
wherein to dynamically modify at least one of the plurality of RF chains comprises to dynamically change an average transmission power of at least one of the plurality of RF chains.

9. The apparatus of claim 5,
wherein to dynamically modify operation of the antenna array comprise to dynamically turn off one or more of the antenna elements.

10. The apparatus of claim 9,
wherein to dynamically turn off one or more of the plurality of antennas elements further comprises to dynamically turn of one or more components of a RF chain associated with the one or more antenna elements to be turned off.

11. The apparatus of claim 5,
wherein to dynamically adjust the MIMO configuration comprises to cause the apparatus to switch from operating according to a single-cell massive MIMO scheme to operating according to a multi-cell joint massive MIMO processing scheme.

12. The apparatus of claim 5,
wherein to dynamically adjust a MIMO configuration comprises to cause the apparatus to switch from operating according to a multi-cell joint massive MIMO processing scheme to operating according to a single-cell massive MIMO scheme.

13. The apparatus of claim 5,
wherein to dynamically adjust the MIMO configuration comprises to operate a subset of the antenna array that includes less than a total number of the plurality of antenna elements of the antenna array.

14. The apparatus of claim 5,
wherein dynamically modifying operation of the at least one processor of the baseband circuitry comprises to dynamically lower an operating frequency of the at least one processor.

15. The apparatus of claim 5,
wherein the at least one memory circuit comprises a plurality of memory circuits, and
wherein dynamically modifying operation of the at least one memory circuit of the baseband circuitry comprises dynamically turning off one or more of the plurality of memory circuits.

16. The apparatus of claim 1,
wherein the at least one processor comprises a plurality of processor cores, and
wherein dynamically modifying operation of the at least one processor of the baseband circuitry comprises dynamically turning off one or more of the processor cores.

17. A method for a base station with a plurality of antenna elements of antenna array to be used to for transmitting according to a multiple-input multiple-output (MIMO) scheme, the method comprising:
determining current traffic conditions in a wireless communication network; and
implementing a dynamic power efficiency operation based on determined current network traffic conditions.

18. The method of claim 17,
wherein implementing the dynamic power efficient operation comprises implementing a sidelobe suppression scheme comprising
defining a plurality of sub-arrays each including a subset of antenna elements from the antenna array, wherein each of the plurality of sub-arrays overlaps with one other sub-array of the plurality of sub-arrays; and
applying a spatial windowing function to signals for each of the plurality of sub-arrays so that each transmission by the plurality of sub-arrays has tapered transmit power profile, and
wherein in response to applying the spatial windowing function, each of the plurality of sub-arrays are configured to transmit with at substantially same power level and a transmit power profile from the antenna array, as a whole, is substantially flat.

19. The method claim 17,
wherein implementing the dynamic power efficient operation comprises performing one or more of the following:
dynamically modifying at least one of a plurality of RF chains of the base station;
dynamically adjusting a MIMO configuration; of the base station;
dynamically modifying operation of the antenna array;
dynamically modifying operation of at least one processor of a baseband circuitry of the base station; and/or
dynamically modifying operation of at least one memory circuit of the base station.

20. One or more non-transitory computer-readable storage media (NTCRSM) comprising instructions, wherein execution of the instructions by one or more processors of a base station is to cause the base station to:
determine current network traffic conditions in a wireless network including the base station; and
implement a dynamic power efficiency scheme based on determining low traffic for the current network traffic conditions, wherein determined low traffic is determined network traffic conditions less than a predefined threshold,
wherein to implement the dynamic power efficiency scheme comprises to perform one or more of the following:
implement a sidelobe suppression scheme comprises to:
define a plurality of sub-arrays of antenna elements from the antenna array, wherein each of the plurality of sub-arrays overlaps with one other sub-array of the plurality of sub-arrays; and
apply a spatial windowing function to signals for each of the plurality of sub-arrays so that each transmission by the plurality of sub-arrays has tapered transmit power profile.
dynamically modify at least one of a plurality of RF chains of the base station;
dynamically adjust a MIMO configuration of the base station;
dynamically modify operation of an antenna array of the base station;
dynamically modify operation of at least one processor of the base station; and/or;
dynamically modify operation of at least one memory circuit of the base station.
